(19) United States
(12) Patent Application Publication
(10) Pub. No.: US 2014/0301727 A1
(43) Pub. Date: Oct. 9, 2014

(54) UNDERWATER LIGHT WITH CAMERA APPARATUS AND RELATED METHODS

(71) Applicant: Eric V. Resh, Temecula, CA (US)

(72) Inventor: Eric V. Resh, Temecula, CA (US)

(21) Appl. No.: 14/216,775

(22) Filed: Mar. 17, 2014

Related U.S. Application Data
(60) Provisional application No. 61/801,543, filed on Mar. 15, 2013.

(51) Int. Cl. G03B 17/08

(52) U.S. Cl. CPC G03B 17/08
USPC 396/28

(57) ABSTRACT

Methods and apparatus are disclosed for underwater swimming pool video monitoring and other data gathering and transmission, and related controls. Embodiments include one or more cameras and/or other sensors and/or controls operatively mounted and/or used with an underwater pool light feature.

This application is based on and claims priority to U.S. provisional application Ser. No. 61/801,543, filed Mar. 15, 2013.

This invention relates broadly to devices for monitoring swimming pools, swimming areas, spas, fountains, water features, and similar bodies of water, and more specifically is directed to apparatus and methods involving an underwater camera that may be incorporated within or otherwise combined with an underwater light. As indicated herein, the inventions disclosed herein can be used in a broad range of applications and provide many benefits.

These and other embodiments will become readily apparent to those skilled in the art from the following detailed description of embodiments having reference to the attached figures, the invention not being limited to any particular preferred embodiment(s) disclosed.

### BACKGROUND OF THE INVENTION

Many prior art swimming pools, spas, fountains, etc. include, among other things, one or more underwater lights, used for aesthetics, safety, extending a pool's usable hours into the evening, allow for at least some pool maintenance/cleaning to occur during other-than-daylight hours, and/or other reasons. Commonly, the lights are mounted in a waterproof light fixture that is positioned in a light niche formed in one of the pool walls or some other similar place. Typically, a power source is provided to the light through a waterproof and/or watertight conduit that extends from the fixture and/or niche in a direction away from the pool. Some examples of prior art lights are the Pentair Amelite and the Hayward ColorLogic brand pool lights.

Prior art underwater light fixtures are generally comprised of a housing with a waterproof cord, a bulb or other light source (i.e. a LED light assembly), a lens, a lens seal, a light ring, and a mounting screw. The housing is generally cone shaped (but often with the narrowest end being flat—instead of pointed—to save space and/or bring other costs savings or benefits) and has a waterproof connector through which a waterproof electrical cord is attached to interior electrical components of the lamp. Typically, the housing has at its other end (opposite the narrow flat end) a lens made of glass, acrylic, and/or other similar rigid and transparent materials to allow the light from the bulb (inside the housing) to shine outwardly from the housing and into the pool. Some prior art LED lights, such as ColorLogic and CrystaLogic made by Hayward, have many similar features, but with more compact housings than standard incandescent lights, and use shallower niches, such as the Hayward Universal ColorLogic Thin Niche.

A lens seal commonly is fitted between the lens and a lip formed around the circumference of the housing's second end. Lens seals vary in shape and style; some enwrap the outermost edges around the entire circumference of the lens, others are more similar to a large O-ring, etc.

Many prior art assemblies also include a light ring that serves multiple functions. For example, light rings are usually compression fittings that, when properly fitted and mounted with clamps, hold the lens and seal tightly against the lip of the housing and create a dry, waterproof area within the housing. Thus, even though the entire lighting assembly is mounted below the pool's water line, the waterproof structures and assemblies typically provide a dry space within the housing, so that bulbs of various sorts (incandescent bulbs, gas bulbs, LED, luminous color wheels, etc.) can be safely mounted inside that dry, waterproof housing.

Light rings further commonly serve as mounting means by which the light fixture may be installed in a pool. In many designs, a screw extends through a hole in the light ring and threads into a threaded hole that is formed or otherwise provided in a mounting tab on or near the outer edge of the light niche. The light niche may typically also include a (second) tab on or near the outer edge of the niche, but approximately 180 degrees opposite the mounting tab. The second tab is positioned to mate with an interlocking feature on the light ring. The second tab can be engaged with the interlocking feature, and then the screw can be threaded into the mounting tab, and the entire assembly thus helps affix the light fixture to the niche in those two places to ensure that the fixture stays mounted in the desired location on the pool wall.

When a pool light such as described above is mounted properly in the pool wall, it completely covers the niche in which the light fixture is mounted in the wall, and thus presents a relatively smooth exterior surface (comprised largely of the lens) to the swimmers in the pool. In other words, the generally/commonly smooth pool walls in the spa or other body of water are largely uninterrupted by the light—the desirably smooth surface extends across the lens and other elements, so that the desired light is provided with minimum protrusions or other elements extending into the water (any such protrusions or extensions might injure persons using the pool or spa, might gather debris or dirt, and/or might have other negative consequences). Another consequence of this assembly and design is that the conduit that brings electrical power to the light is generally inaccessible under normal circumstances, to persons using the pool and/or generally.

Prior art underwater light fixtures typically have a very limited functionality. Pool lights typically turn ‘on’ and ‘off’ and have no other function than to light the pool.

As mentioned above, underwater lights can improve the safety and security of pools and similar bodies of water. Prior art pools also have included other security measures, such as fencing around the pools. Cameras are sometimes used to monitor swimming pools, in ways that are similar/identical to cameras used to monitor parking lots, public places, etc. Such cameras typically are installed and used in the same manner as for monitoring those other places; e.g., they are mounted well above the pool water's surface and may have connectivity (wireless or otherwise) to computers, smart phones, tablets such is iPads, blue tooth compatible televisions, etc. Multiple cameras of this type can be used to provide monitoring coverage of most or even all of the pool surface and/or the area surrounding the pool. Some such systems not only have data transmission and connectivity as described above, but are used with other hardware and software that enable two or more camera angles/images to be displayed on a single screen. Body and face recognition are used in some pool security systems to detect the ages of swimmers and provide other monitoring. Some camera security/safety systems even include underwater cameras for detecting potential drowning victims, and can alert lifeguards when they detect a swimmer that has sunk to the bottom of the pool and/or has stopped moving/breathing (see FIG. 1A for an example of a Poseidon system).

Prior art underwater cameras for such pool installations and uses are typically secondary or “aftermarket” items that can be placed into pool water temporarily (by laying them on the floor of the pool or dangling them into the water from the pool deck). Some cameras are more permanent in nature, and can be installed in a niche similar to that which may hold a pool light (examples include a mounted unit made by Poseidon). These devices typically use one lens or a plurality of lenses, depending upon the camera model.

Some of the problems with prior art underwater cameras are associated with their ‘temporary’ use or portable designs. They may be bumped, accidentally moved, or even interfere with the activities of swimmers. They may be difficult to place in a pool in a useful way (i.e. not be at a sufficient location or depth to capture substantial views of swimming areas), damaged during setup or transport, and/or even pose hazards to swimmers both in and out of the pool (i.e. many such cameras have long cords that stretch across the pool or the pool deck). There may not be appropriate or sufficient lighting in the area where the camera is placed, for the camera to be able to capture/transmit desirably high-quality images.

Even for underwater cameras mounted in niches, the “camera niche” typically is used for the single purpose of mounting the camera underwater. Both the niche and the waterproof or watertight conduit connecting the niche to an above ground junction power and/or power source are fully occupied by the camera and its cord, respectively. Prior art underwater light fixtures typically have the same characteristic—they fill their pool wall niches and related conduit so completely that neither the niches nor the conduit can serve any other purpose than to bring power (and/or light through a fiber optic cable in some cases) to the light fixture.

### BRIEF DESCRIPTION OF THE DRAWINGS

FIG. 1A is a graphic depiction of a prior art Poseidon system, from the website http://www.poseidon-tech.com/us/system.html.

FIG. 1 is a perspective view of an embodiment of a pool light and camera combination constructed in accordance with the current invention, in which the camera and/or camera lens is mounted inside a waterproof light housing.

FIG. 2 is similar to FIG. 1, but illustrates one of the many alternative embodiments the invention, in which a plurality of cameras/lenses are used.

FIG. 3 is a side view of an alternative embodiment of FIG. 1, but shows one of the many ways in which the light's lens can be modified to accommodate a camera or camera lens.

FIG. 4 is a sectional side view of a pool wall showing the embodiment of FIG. 3 in one of the many ways in which it may be mounted in a niche with conduit.

FIG. 5 is similar to FIG. 4, but shows one of the many alternative embodiments of the invention, showing a camera operably formed into or otherwise positioned on or in the assembly's light ring.

FIG. 6 also is similar to FIG. 4 and FIG. 5, but illustrates another of the many alternative embodiments of the invention, in which the camera is a separate element from the light fixture and light ring and is held in place by the light ring's mounting screw.

FIG. 7 illustrates some of the many other alternative embodiments of the invention.

FIG. 8 illustrates yet another of the many other alternative embodiments of the invention. In this drawing, element 5 is a camera, element 7 is a barrier to separate the camera from the rest of the dry housing area, and 18 is a bulb (in this case, an LED lamp). Pool lights of prior art in recent years have followed trends towards multi-colored illumination, some having one or more of the following within the housing: light bulbs (incandescent or otherwise), multicolored translucent color wheels, mechanical devices for changing color/brightness, and electronic circuitry. There have also been trends towards energy efficiency, and while incandescent bulbs are still commonly used, energy saving components such as LED lamps and fiber optic sources have become increasingly popular. LED lamps, as shown above in FIG. 8, save electricity, may be designed to change many colors, and last for thousands of hours. They can further be designed to be space-saving without compromising brightness, making them a suitable alternative to incandescent bulbs in swimming pool lights.

FIG. 9 illustrates a relatively compact camera light that can be positioned inside a relatively “thin” niche. Its desired compact configuration can be accomplished by various design choices, such as (for example, and among other things) using small and/or LED lights to reduce the overall depth (horizontally into the wall, in the view of FIG. 9) required for the light element, and/or by using internal circuitry and/or moving parts within the housing.

FIGS. 10 and 10A illustrate two of the many embodiments of a control panel element/interface of the invention.

### DETAILED DESCRIPTION OF EMBODIMENTS

As indicated above, the inventions disclosed herein can be used in a broad range of applications and provide many benefits. Embodiments of the present invention will now be described with references to the accompanying figures, wherein like reference numerals refer to like elements throughout.

Persons of ordinary skill in the art will understand that the apparatus of the invention and variations of its many methods can be practiced using any of a wide variety of suitable processes and materials.

An object of the invention is to provide an improved underwater light fixture that does more than merely light a swimming pool, spa, swimming area, fountain, or similar body of water. In one embodiment, the light fixture has a waterproof housing that contains all the components similar to and necessary for a functioning pool light (i.e. one or more light bulbs, lens, lens gasket, waterproof cord, light ring, niche connections, etc.) and further includes a camera. The camera is preferably located behind the lens (that is to say, inside the waterproof housing) and can capture underwater images (still photos and/or video) of the swimming pool. Preferably, the camera has connectivity (wireless or otherwise) to pool equipment controllers, computers, smart phones, tablets such is iPads, blue tooth compatible televisions, etc.

Another embodiment provides for a camera mounted inside a pool light fixture, in which more than one camera lens is used to capture underwater images of the pool. Each lens, depending upon the way it is mounted/adjusted, preferably is able to capture a distinct angle of the pool, thus better ensuring relatively complete video coverage of the pool's underwater areas.

Yet another embodiment provides for an underwater pool light mounted to a niche in a pool wall or other pool surface and containing a camera lens or lenses that can be adjusted to change viewing location. Adjustments may be done either manually (with mechanical features such as levers, knobs, screws, repositionable brackets, etc.), automatically (on a programmed/timed movement pattern or in response to tracking sensors, heat sensors, motion sensors, or the like), and/or electronically via remote access.

A further embodiment of the invention provides for an underwater pool light mounted within a wall niche, in which the light fixture contains at least one camera and/or camera lens(es). The camera lens(es) have mechanical/optical/digital zoom features that can be adjusted by a user via remote access.

Yet another embodiment of the invention provides for an underwater pool light mounted within a wall niche, in which the light fixture contains one or more cameras and/or camera lens, in which the zoom features and/or position of camera lens or lenses can be adjusted by controls, electronic or mechanical, mounted on or near the light ring.

A further embodiment of the invention provides for an underwater pool light mounted within a wall niche, in which the light ring contains at least one camera and/or camera lens(es).

A further embodiment of the invention provides for an underwater pool light mounted within a wall niche, in which the light ring contains at least one camera and/or camera lens(es). The lens(es) in/on the light ring further are designed to be low in profile and/or have smooth sides, edges and corners, and be safe for swimmers.

Yet another embodiment provides for an underwater pool light mounted within a wall niche, in which the light ring contains at least one camera and/or camera lens(es). The lens or lenses can be adjusted manually via at least one mechanical adjustment device.

Yet another embodiment provides for an underwater pool light mounted within a wall niche, in which the light ring contains at least one camera and/or camera lens(es). The camera lens or lenses can be adjusted by controls, electronic or mechanical, within or near the light ring.

Yet another embodiment provides for an underwater pool light mounted within a wall niche, in which the light ring contains at least one camera and/or camera lens(es). The camera lens(es) have mechanical/optical/digital zoom features that can be adjusted by a user via remote access.

Certain embodiments of the invention provide a plurality of underwater lights with cameras installed in them and/or in their light rings. Among others, such embodiments can be readily implemented in swimming environments that have a plurality of underwater lights (i.e. a pool and spa combination, an Olympic size pool with many lights, a gym with multiple pools and spas, etc.).

Yet another object of the invention is a pool light with a camera or cameras mounted in it, its light ring, or both, in which the camera's power/connectivity cord is sealed or otherwise operatively disposed or located with the light's power cord. Preferably, conduit suitable for pool lights or similar electrical fixtures carries the combined power/camera connectivity cord to a junction box and/or power source and/or pool equipment controller, Bluetooth, wireless, cable, etc. connection.

Still another object of the invention is to provide an underwater camera designed to be mounted with and/or adjacent to a pool light using the mounting screw or another mountable feature of the light ring.

Yet another object of the invention is to provide a pool light and/or light ring that further includes sensors that can detect water for chemicals (chlorine, acid, etc.) and/or conditions of swimming pool environment (i.e. temperature, underwater audio, etc.). Such sensors may further be combined with a camera or cameras mounted in the light or light ring. Sensor data of this type preferably is transmitted (by itself, if no camera is present in the embodiment, or along with data from the camera for other embodiments) via wireless transmission or otherwise, to pool equipment controllers, computers, smart phones, tablets such is iPads, blue tooth compatible televisions, etc.

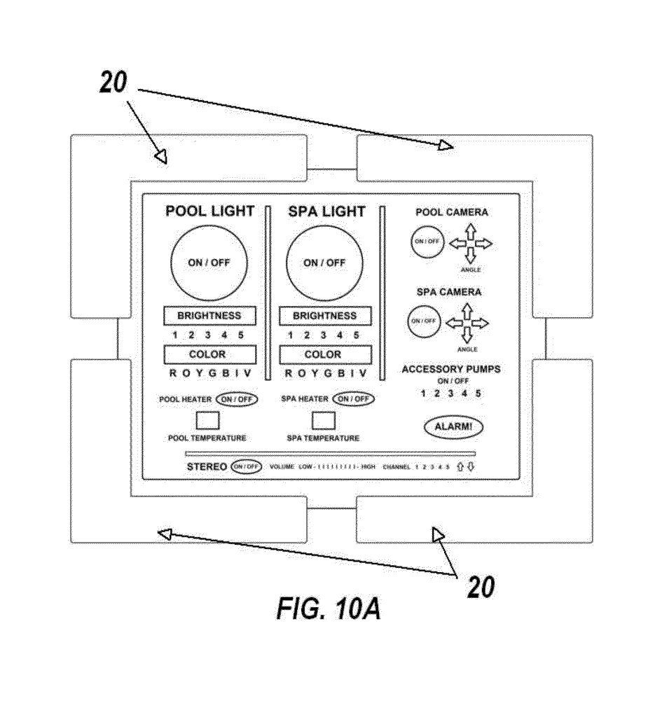

Yet another object of the invention is to provide an apparatus and/or methods by which a swimmer (or other person in the pool/spa/etc.) may make changes in the swimming pool environment. Embodiments of such apparatus can include one or more controls mounted on or adjacent the pool light and/or light ring, and can include one or more buttons, switches, touchscreens, or similar control components, configured to permit the swimmer/user to control and/or adjust pool equipment such as the pool light, camera, pool equipment, etc. By way of examples and not by way of limitation, a swimmer/user preferably can use the control element(s) to change the color and/or brightness of the pool light(s), adjust functions or angle(s) of the pool light and/or camera, activate an alarm, control a sound system and/or television and/or other appliances (entertainment or otherwise), raise/lower water temperature, turn on/off or adjust various pieces of pool equipment (i.e. spa jet pumps, waterfall pumps, automatic cleaner equipment, etc.) and the like without a need for the swimmer/user to leave the pool and/or pool environment. Such buttons, switches, fixed/remote controls/interfaces (such as the app/interface illustrated in FIG. 10) and or similar control components may further include special features to make them easily identifiable to a swimmer, such as lighted portions (LED or otherwise), color coding (lighted or otherwise), identifiable textures/shapes/sizes, and even patterned arrangement on the light or light ring. Such control components preferably function via wireless and/or Bluetooth transmission or otherwise, to control various pool equipment and nearby devices.

Yet another object of the invention is to provide an (at least partially) underwater and/or submersible control center of the aforementioned character. Preferably, the apparatus and methods would provide a “control center” that is actually “in the water” to at least some degree, and can include a corresponding niche with waterproof/watertight conduit as discussed above. In certain embodiments, the apparatus includes at least a control panel or similar device that further includes buttons, switches, a touchscreen, or similar control components that can control equipment such as the pool light, camera, pool equipment, etc., through which a swimmer may make changes in the swimming pool environment (i.e. change the color and/or brightness of the light, adjust functions or angle(s) of the pool light and/or camera, activate an alarm, control a sound system and/or other appliances (entertainment or otherwise), raise/lower water temperature, turn on/off or adjust various pieces of pool equipment (i.e. spa jet pumps, waterfall pumps, automatic cleaner equipment, etc.) and the like without a need for the swimming pool to leave the environment. Such buttons, switches, and or similar control components may further include special features to make them easily identifiable to a swimmer, such as lighted portions (LED or otherwise), color coding (lighted or otherwise), identifiable textures/shapes/sizes, and even patterned arrangement on the light or light ring. In certain embodiments, the control center is positioned in a niche and/or ‘dock’ and at least some of its power source and/or buttons, switches and/or control components function via wires that reach the control center through a watertight conduit such as described above, and may further include wireless transmission or otherwise, to pool equipment controllers, computers, smart phones, tablets such is iPads, blue tooth compatible televisions, etc. Persons of ordinary skill in the art will understand that such controllers may also control devices and systems remote from and/or not associated with the pool, such as lights and/or heating/AC within a house or building near the pool, a nearby spa, etc.

Yet another object of the invention is to provide a relatively waterproof portable control center similar to that described above. For example, and similar to the above description, such portable embodiments preferably include the types of interfaces described above and the ability to control functions/systems/devices described above.

Among other embodiments, this can be provided as a pool equipment controller to control some or all of the cameras or other technology in the pool environment. Such controller elements can include a touchscreen interface, and/or can be provided in a relatively permanent fixture mounted on or adjacent the light assembly (underwater or above water), and/or in another location, or within or near the pool environment, and/or on a mobile devices such as a smartphone or tablet or iPad or the like, and/or in the form of a downloadable app. Persons of ordinary skill in the art will understand that this can even be provided in the form of a waterproof portable device that is preferably “floating” or otherwise cushioned/protected (such as, by way of example, via one or more float/corner protection elements 20, FIG. 10A, made from rubber or foam or other suitable material and affixed to the controller via friction, adhesive, or otherwise), so as to be readily usable within the pool or pool area and/or to reduce the risks that might be associated with accidentally dropping it into the pool or onto the pool deck, etc. Persons of ordinary skill in the art will understand that the protection/float means can be provided in any of a wide variety of suitable configurations and materials.

Persons of ordinary skill in the art likewise will understand that, in certain embodiments, the data being captured/viewed by the camera can also be viewed/displayed via the app or another screen on the control panel.

Certain embodiments of such portable control center embodiments are rechargeable and designed to be positioned or located or stored (at least temporarily) in a niche or ‘dock.’ For certain embodiments, at least some aspect of the control center (the power source (or battery charging/recharging source) and/or buttons, switches and/or control components) function or interact with the portable control via wires that extend through a watertight conduit such as described above, and may further include wireless transmission or otherwise, to pool equipment controllers, computers, smart phones, tablets such is iPads, blue tooth compatible televisions, etc. The waterproof control panel may have buoyancy features/components that enable it to float and/or other features/components that protect it from damage caused by impact or other hazards (electrical or otherwise). In certain embodiments, the control panel preferably is easily and safely removed from its charging dock, taken and used virtually anywhere in or around the pool environment, and easily returned to its charging dock. The dock can be at any convenient location, including for example either in or out of the water. It could be at the tile line of a pool/spa, near the steps and/or shallow end of a pool, by the pool equipment or even in the house or an adjacent building.

Yet another object of the invention is a pool light with a camera or cameras mounted in it, its light ring, or both, in which the power/connectivity cord of the camera is at least partially separated from the light's power cord. Conduit suitable for pool lights or similar electrical fixtures carries the light's power cord and camera connectivity cord to a junction box and/or power source and/or pool equipment controller, Bluetooth, wireless, cable, etc. connection.

Persons of ordinary skill in the art will readily understand that the invention preferably can be practiced with a wide range of pool equipment controllers, computer operating systems, cameras (i.e. indoor and/or outdoor security systems, pool alarms, entertainment systems, swimming/sports equipment, etc.), and other technologies, including those that may be developed in the future.

By way of example and not by way of limitation, certain embodiments of the apparatus can be manufactured via processes using one or more steps of injection molding, gluing, bonding, shaping, milling, drilling, injection molding, thermo-forming, casting, and many other existing and new processes that may come into being. Materials are not limited in any way and could extend to include at least certain parts of the apparatus being made from metals to plastics, to resins of all types. A preferred material is lightweight, non-corrosive and will hold up to the exposure anticipated in its eventual usage (including by way of example, chemical reagents, chlorinated water, acidic water, salt water, marine environments, UV exposure, etc.). A preferred method of manufacture is by injection molding and coloring various components of the embodiments, and by machining others and/or buying them from commercially-available sources.

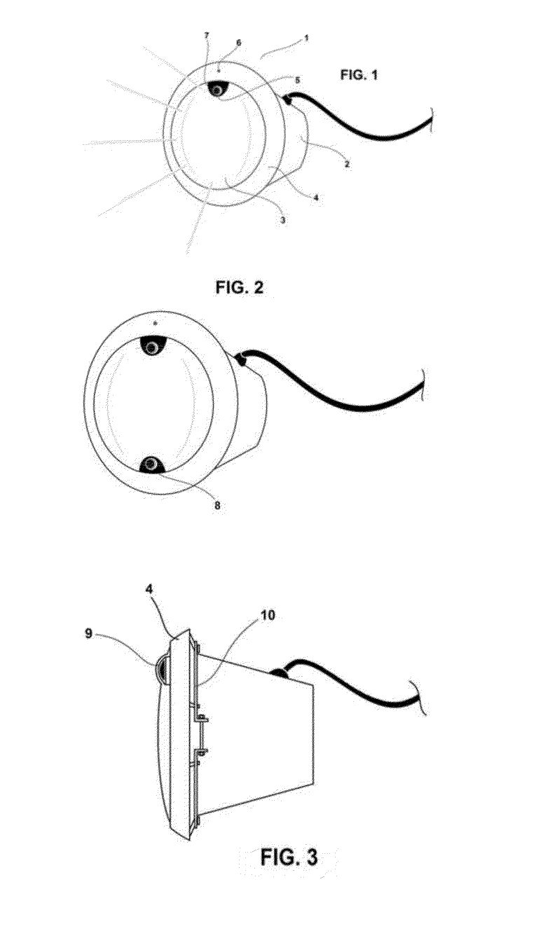

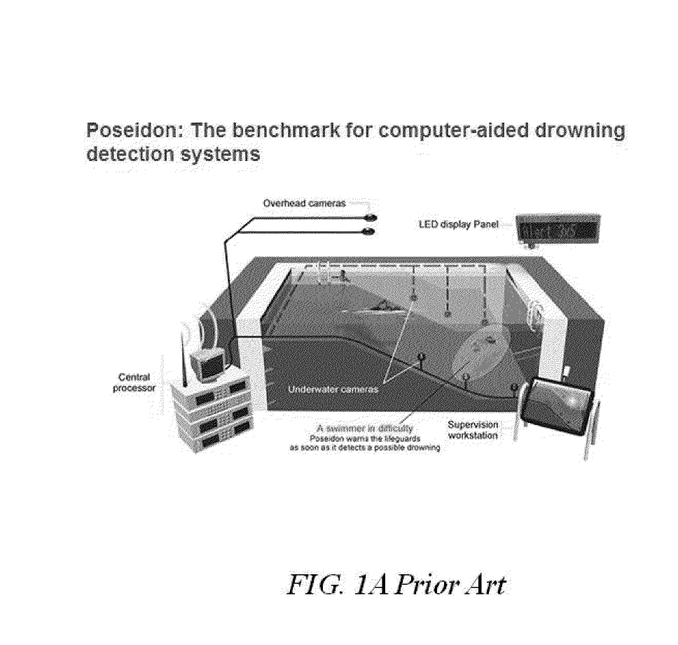

Referring now to the drawings, and particularly to FIGS. 1, 2 and 3, one embodiment of an underwater light and camera 1 includes a housing 2, a light lens 3, a light ring 4, a camera and/or camera lens 5, a mounting screw 6, and a power cord. Preferably, a barrier 7 is provided to isolate the camera from the lamp compartment. Incandescent light bulbs produce not only light, but heat, and such isolation may sometimes be necessary to prevent the camera and/or camera lens from damage caused by excessive heat. Furthermore, the camera lens and light bulb are positioned on the same side of the light's lens, and a barrier can shield the camera from receiving glare from light reflecting within the housing. It is worth noting that not all lamps produce heat (e.g. fiber optic pool lights utilize lamps that are positioned above ground, with the fiber optic cables bringing light to the housing instead of electricity), and not all lenses produce glare (lenses may be treated with glare reducing coatings, formed with convex surfaces, etc.). Thus, some embodiments of the invention may need barriers to isolate the camera while other embodiments may not. The way light passes through a lens varies and can be controlled, to some extent, by the lens' texture(s) and thickness(es). For example, bumps and ridges (patterned or otherwise) can cause light to diffuse as it goes out from a light source (e.g., the diffusing bumps and ridges commonly found on flood lamps and automobile headlights), while the absence of bumps and/or ridges may allow light to pass more directly through a lens (i.e. the way a light in a house can be clearly seen through a window). Thus, the lens of a pool light with a camera can have various diffusing features, patterned or otherwise, along some or all of it, depending on the position of the camera in relation to the light source, the desired functionality of the system, and other factors. Additionally, more camera coverage of the pool area can be provided by a secondary camera 8 (see FIG. 2) as, for example, one camera can point relatively more upwardly (to capture video/photos of the surface and shallow waters) while the other can be directed to shots of deeper water. Persons of ordinary skill in the art will understand that sideways variations and angles in camera direction also can be used, and that overlapping coverage may be provided in certain embodiments. Among other factors, camera positioning and visibility may depend upon the camera's location relative to the pool light lens and the pool light's position in the pool. Adjustment features for camera lens position and zoom, etc. (not shown) may be used to enhance camera effectiveness (quality of the video/photos, depth of perception of the camera into the pool, etc.).

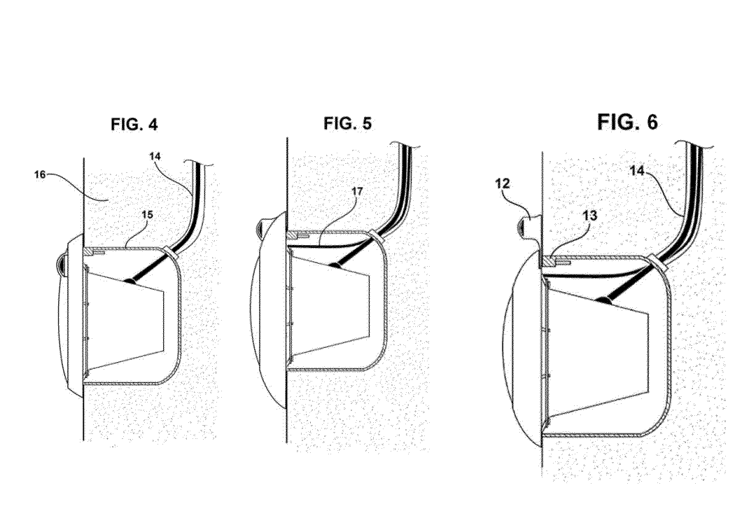

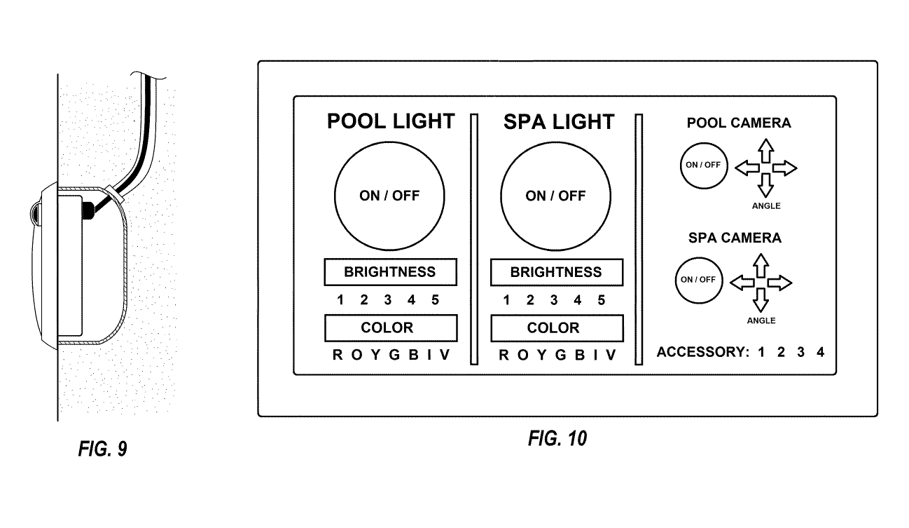

Another preferred embodiment includes a camera that is mounted behind the light's lens and within the lamp housing. In FIG. 3, the light's lens 9 includes a distinctly shaped portion to accommodate the camera, to enhance the security and/or the placement of the camera within the light housing. A clamp 10 may be at least partially attached to the light ring to keep the housing water tight, and preferably can be loosened to allow access to the bulb and/or camera within the light's housing. In FIG. 4, the light/camera of FIG. 3 is shown mounted in a pool wall 16, and both the light and camera share a power cord (or a harness) that runs through conduit 14 connected to the light niche 15. For the purpose of clarity, the power cords and/or camera cords lengths in FIGS. 4, 5, 6, and 9 have been simplified and are shown as taking up very little space within the light niche. However, in real settings, most pool light niches are filled with several feet of excess cord (some even up to a couple of yards or more) that enable a light to be removed from its niche and taken above the pool surface for service or repair.

Alternative embodiments in FIGS. 5 and 7 demonstrate some of the many configurations associated with mounting a camera or cameras (or other sensors) within and/or onto the light ring. The camera's cord 17, which is shown as coming out of the light ring, shares the conduit with the light cord. Camera controls and/or sensors 11 may further be installed onto or within elements of the light ring and may enable swimmers to make camera or light adjustments and may allow viewers to see and know more about the pool environment that is under observation.

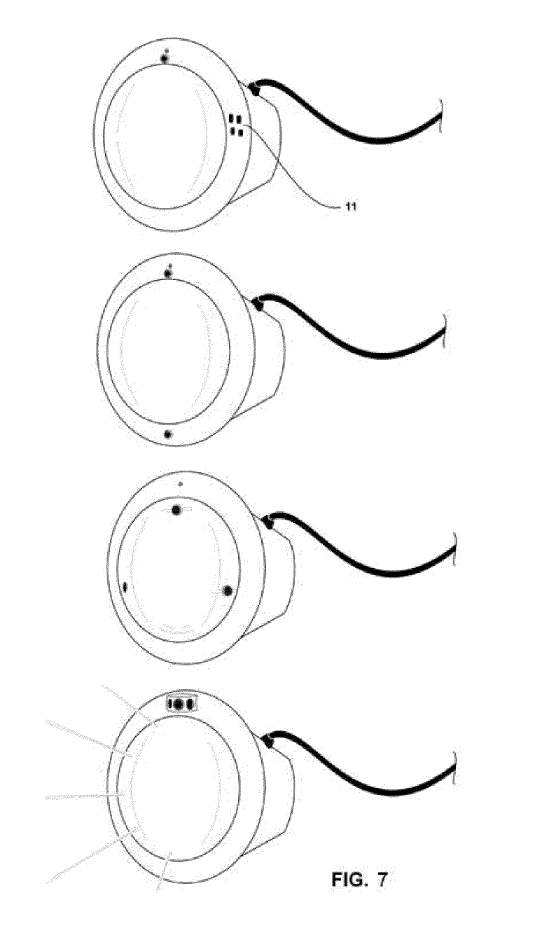

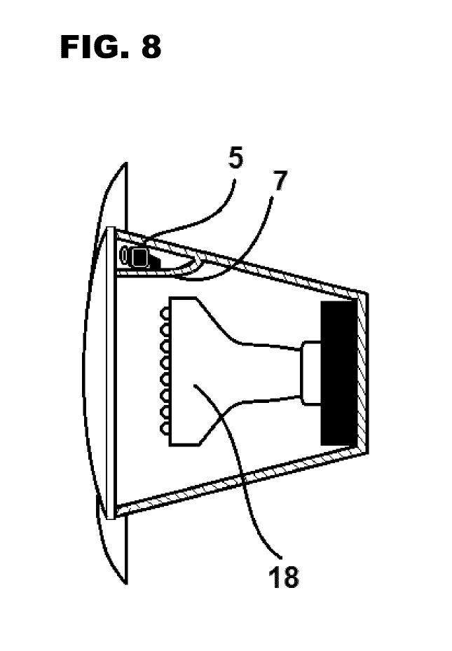

Alternative embodiments include using one or more components of the pool light to install an underwater camera. In FIG. 6, a separate underwater camera is installed on and/or retrofitted onto a pool light of prior art. The camera is designed to utilize both (a) the mounting screw/niche tab 13 in the light ring and (b) the conduit 14. In this embodiment, as with some embodiments providing a camera within the light ring, it may be quite challenging to pull the camera cord through the conduit if the light cord has already been installed in the conduit (the size of the conduit may be too small for both cords, have too many curves, etc.). In such cases, installing a camera cord would most likely require the complete removal of the first (installed) cord, and both would then need to be pulled through the conduit at the same time. Moreover, extra cord for the light is often stored in the light niche (i.e. wrapped around the housing several times) so that the light fixture may be temporarily removed from the niche and brought up out of the water for repair or bulb replacement. Wrapping a second camera cord in the same niche with a light cord could be problematic as there may not be enough space in the niche for both, the two could become tangled, etc. Therefore, a single cord and/or wire harness (the same as or similar to the cord 14 in FIG. 4) eliminates problems associated with using two cords in a single length of conduit, especially in settings where a new pool light with an internal camera is retrofitted into older niches and conduit.

The present invention is described herein with reference to the accompanying Figures, which serve as illustrations of some of the many embodiments in which the invention may be practiced. Subject to the context and other factors (including for example the understanding of persons of ordinary skill in the arts relevant to the inventions), generally in those Figures and references similar reference numerals refer to similar or identical elements throughout this description.

Those Figures and references, and the other terminology used in these descriptions, are not intended to be interpreted in any limited or restrictive manner, simply because it is being utilized in conjunction with a detailed description of certain embodiments of the invention. Furthermore, various embodiments of the invention (whether or not specifically described herein) may include one or more of the novel features disclosed herein, no single one of which (a) is necessarily solely responsible for any particular desirable attribute(s) of the inventions or (b) is essential to practicing the inventions described.

For the purpose of summarizing the invention, certain objects and advantages have been described herein. It is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

The apparatus and methods of the invention have been described with some particularity, but the specific designs, constructions, and steps disclosed are not to be taken as delimiting of the invention. A wide range of modifications and alternative structures and steps for practicing the invention will make themselves apparent to those of ordinary skill in the art, all of which will not depart from the essence of the invention, and all such changes and modifications are intended to be encompassed within the appended claims.

Although the examples of the many various methods of the invention are described herein with steps occurring in a certain order, the specific order of the steps, or any continuation or interruption between steps, is not necessarily intended to be required for any given method of practicing the invention.

What is claimed is:

1. Apparatus for accessing data underwater in swimming pools and similar environments, including:
a camera operatively mounted with an underwater pool light feature.

2. The apparatus of claim 1, including a plurality of such cameras.

3. The apparatus of claim 1, including a plurality of such light/camera combinations within a single pool installation.

4. The apparatus of claim 1, including a sensor other than a light and other than a camera, said sensor operatively mounted with an underwater pool light feature.

5. A method of accessing data underwater in swimming pools and similar environments, including the steps of:
providing the apparatus of claim 1 or claim 3 or claim 4;
operating the camera to transmit data from the underwater area of the pool to a remote location for viewing or other action.

6. Apparatus for controlling devices associated with a swimming pool and/or similar environments, including:
a camera operatively mounted with an underwater pool light feature; and
a control panel configured to control the camera and/or the underwater pool light.
